(19) United States
(12) Patent Application Publication
(10) Pub. No.: US 2022/0391044 A1
(43) Pub. Date: Dec. 8, 2022

(54) DYNAMIC PRESENTATION ADJUSTMENT

(71) Applicant: International Business Machines Corporation, Armonk, NY (US)

(72) Inventors: Lei Huang, Mountain View, CA (US); Guangjie Ren, Belmont, CA (US); Robert John Moore, San Jose, CA (US); Shun Jiang, San Jose, CA (US); Pawan Chowdhary, San Jose, CA (US); Eric Young Liu, Santa Clara, CA (US); Chung-hao Tan, San Jose, CA (US)

(21) Appl. No.: 17/338,737

(22) Filed: Jun. 4, 2021

(51) Int. Cl. G06F 3/0481; G06Q 30/02; G06Q 50/00

(52) U.S. Cl. CPC G06F 3/0481; G06Q 30/0201; G06Q 50/01; G06Q 10/10

(57) ABSTRACT

A tool for providing dynamic context-based presentation adjustments across one or more computer devices. The tool receives a presentation from at least one of a plurality of user devices. The tool collects real-time contextual data associated with the presentation from at least one of the plurality of user devices. The tool analyzes the real-time contextual data utilizing a training model. The tool determines one or more adjustment actions based, at least in part, on the analysis of the real-time contextual data. The tool modifies the presentation in real-time using the one or more adjustment actions.

### BACKGROUND OF THE INVENTION

The present invention relates generally to computing device functionality, and more particularly to dynamic context-based presentation adjustments.

A presentation is a process of presenting a topic to an audience. It is typically a demonstration, introduction, lecture, or speech meant to inform, persuade, inspire, motivate, or present a new idea. A slide show is a digital presentation including one or more slides that make up a slide deck. The quality of a digital presentation is critical for success in academic, industry, and business settings.

### SUMMARY

Aspects of an embodiment of the present invention disclose a method, computer program product, and computer system for providing dynamic context-based presentation adjustments across one or more computer devices. The method includes receiving, by one or more computer processors, a presentation from at least one of a plurality of user devices. The method includes collecting, by the one or more computer processors, real-time contextual data associated with the presentation from at least one of the plurality of user devices. The method includes analyzing, by the one or more computer processors, the real-time contextual data utilizing a training model. The method includes determining, by the one or more computer processors, one or more adjustment actions based, at least in part, on the analysis of the real-time contextual data. The method includes modifying, by the one or more computer processors, the presentation in real-time using the one or more adjustment actions.

### BRIEF DESCRIPTION OF THE DRAWINGS

FIG. 1 illustrates a data processing environment, generally designated 100, in accordance with an embodiment of the present invention.

FIG. 2 is a flowchart depicting operational steps of a dynamic adjustment program, such as the dynamic adjustment program of FIG. 1, generally designated 200, for providing dynamic context-based presentation adjustments, in accordance with an embodiment of the present invention.

FIG. 3 is a block diagram depicting components of a data processing environment, such as the server of FIG. 1, generally designated 300, in accordance with an embodiment of the present invention.

### DETAILED DESCRIPTION

Embodiments of the present invention recognize that an effective slideshow presentation is crucial for success in academic, industry, and business settings. Embodiments of the present invention further recognize that current presentation tools are limited by a linear design that requires time consuming manual efforts of a drafter to revise in order to appeal to a variety of audiences. Embodiments of the present invention further recognize that current presentation tools fail to capture contextual information from presenters, audiences, and various other factors. Embodiments of the present invention recognize that current presentation tools passively receive commands and actions from presenters and cannot intelligently and proactively interact with the presenters.

Embodiments of the present invention provide the capability to analyze and effectively capture static and real-time contextual data related to a presentation. Embodiments of the present invention further provide the capability to analyze and model contextual data related to a presentation by leveraging machine learning models. Embodiments of the present invention further provide the capability to predict adjustment actions for a presentation based, at least in part, on captured real-time contextual data related to the presentation. Embodiments of the present invention further provide the capability to automatically generate new content for a presentation based on captured contextual data and modify existing content of the presentation in real-time to enhance audience appeal and facilitate a more thorough consumption of presented information.

Implementation of such embodiments may take a variety of forms, and exemplary implementation details are discussed subsequently with reference to the Figures.

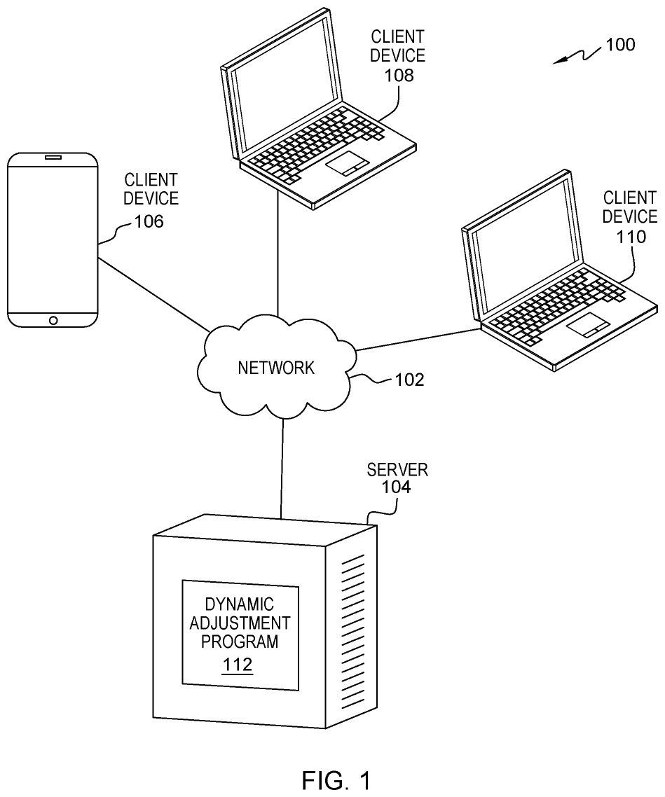

Referring now to various embodiments of the invention in more detail, FIG. 1 is a functional block diagram that illustrates a data processing environment, generally designated 100, suitable for providing dynamic context-based presentation adjustments across one or more computer devices, in accordance with at least one embodiment of the invention. The present invention will now be described in detail with reference to the Figures. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. FIG. 1 includes network 102, server 104, which includes dynamic adjustment program 112, and one or more client devices, such as client device 106, client device 108, and client device 110.

In one embodiment, network 102 is the Internet representing a worldwide collection of networks and gateways that use TCP/IP protocols to communicate with one another. Network 102 may include wire cables, wireless communication links, fiber optic cables, routers, switches and/or firewalls. Server 104, client device 106, client device 108, and client device 110 are interconnected by network 102. Network 102 can be any combination of connections and protocols capable of supporting communications between server 104, client device 106, client device 108, client device 110, and dynamic adjustment program 112. Network 102 can be, for example, a telecommunications network, a local area network (LAN), a virtual local area network (VLAN), a wide area network (WAN), such as the Internet, or a combination of the three, and can include wired, wireless, or fiber optic connections. Network 102 may include one or more wired and/or wireless networks that are capable of receiving and transmitting data, voice, and/or video signals, including multimedia signals that include voice, data, and video information. In general, network 102 may be any combination of connections and protocols that will support communications between server 104, client device 106, client device 108, client device 110, and dynamic adjustment program 112, as well as other computing devices (not shown) within data processing environment 100. FIG. 1 is intended as an example and not as an architectural limitation for the different embodiments.

In one embodiment, server 104 may be, for example, a server computer system such as a management server, a web server, or any other electronic device or computing system capable of sending and receiving data. In another embodiment, server 104 may be a data center, consisting of a collection of networks and servers, such as virtual servers and applications deployed on virtual servers, to an external party. In another embodiment, server 104 represents a “cloud” of computers interconnected by one or more networks, where server 104 is a computing system utilizing clustered computers and components to act as a single pool of seamless resources when accessed through network 102. This is a common implementation for data centers in addition to cloud computing applications. In one embodiment, server 104 includes dynamic adjustment program 112 for providing dynamic context-based presentation adjustments across one or more computer devices, such as illustrated by client device 106, client device 108, and client device 110, respectively.

In one embodiment, dynamic adjustment program 112 operates on a central server, such as server 104, and can be utilized by one or more client devices, such as client device 106, client device 108, and client device 110, via an application download from the central server or a third-party application store and executed on the one or more client devices. In another embodiment, dynamic adjustment program 112 may be software, downloaded from a central server, such as server 104, and installed on one or more client devices, such as client device 106, client device 108, and client device 110. In yet another embodiment, dynamic adjustment program 112 may be utilized as a software service provided by a third-party cloud service provider (not shown). In yet another embodiment, dynamic adjustment program 112 may include one or more fully integrated components (not shown), such as add-ons, plug-ins, and agent programs, etc., or one or more components installed on one or more client devices, such as client device 106, client device 108, and client device 110, to provide dynamic context-based presentation adjustments across one or more computer devices. In one embodiment, dynamic adjustment program 112 can be an add-on feature to a computer program (e.g., presentation program, presentation management tool, communication program, web browser, social media application, video conferencing program, etc.) that provides a user the ability to utilize dynamic context-based presentation adjustments across one or more computer devices. In one embodiment, dynamic adjustment program 112 can be fully integrated, partially integrated, or separate from a third-party service (e.g., collaboration service, communication service, etc.). In one embodiment, dynamic adjustment program 112 may be an application, downloaded from an application store or third-party provider, capable of being used in conjunction with a computer program during interactions between one or more authorized users utilizing a plurality of user devices, such as client device 106, client device 108, and client device 110, to provide dynamic context-based presentation adjustments across one or more computer devices.

In one embodiment, dynamic adjustment program 112 can be utilized by one or more user devices, such as client device 106, client device 108, and client device 110, to provide dynamic context-based presentation adjustments across one or more computer devices. In one embodiment, dynamic adjustment program 112 provides the capability to provide dynamic presentation slide adjustment functionality that considers contextual data gather before, during, and after a presentation. In one embodiment, dynamic adjustment program 112 provides the capability to monitor one or more input and output sensors across one or more computer devices, such as client device 106, client device 108, and client device 110, for associated contextual data related to a presentation. In one embodiment, dynamic adjustment program 112 provides the capability to collect static and real-time contextual data, such as stage setting, audience type, real-time feedback, and time remaining, etc. In one embodiment, dynamic adjustment program 112 provides the capability to predict presentation slide adjustment actions, as well as results of implementing the predicted adjustment actions. In one embodiment, dynamic adjustment program 112 provides the capability to analyze and model collected contextual information and based, at least in part, on natural language processing (NPL) techniques and machine learning (ML) techniques, and dynamically modify presentation slides in real-time based on predicted results.

In one embodiment, dynamic adjustment program 112 may be configured to access various data sources, such as a database or repository (not shown), that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In one embodiment, dynamic adjustment program 112 enables the authorized and secure processing of personal data. In one embodiment, dynamic adjustment program 112 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In one embodiment, dynamic adjustment program 112 provides information regarding personal data and the nature (e.g., type, scope, purpose, duration, etc.) of the processing. In one embodiment, dynamic adjustment program 112 provides a user with copies of stored personal data. In one embodiment, dynamic adjustment program 112 allows the correction or completion of incorrect or incomplete personal data. In one embodiment, dynamic adjustment program 112 allows the immediate deletion of personal data.

In one embodiment, client device 106, client device 108, and client device 110 are clients to server 104 and may be, for example, a desktop computer, a laptop computer, a tablet computer, a personal digital assistant (PDA), a smart phone, a thin client, or any other electronic device or computing system capable of communicating with server 104 through network 102. For example, client device 106 may be a mobile device, such as a smart phone, capable of connecting to a network, such as network 102, to access the Internet, utilize a presentation program, one or more software applications, and one or more input/output devices (e.g., camera, microphone, speakers, etc.). In another example, client device 108 and client device 110 may be a user device authorized for access by one or more additional users. In one embodiment, client device 106, client device 108, and client device 110 may be any suitable type of client device capable of executing one or more applications utilizing a mobile operating system or a computer operating system. In one embodiment, client device 106, client device 108, and client device 110 may include a user interface (not shown) for providing a user with the capability to interact with dynamic adjustment program 112, and one or more authorized users via a computer device, such as client device 108 and client device 110. A user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In one embodiment, client device 106, client device 108, and client device 110 may be any wearable electronic devices, including wearable electronic devices affixed to eyeglasses and sunglasses, helmets, wristwatches, clothing, wigs, tattoos, embedded devices, and the like, capable of sending, receiving, and processing data. In one embodiment, client device 106, client device 108, and client device 110 may be any wearable computer capable of supporting dynamic context-based presentation adjustments across one or more computer devices. In one embodiment, client device 106, client device 108, and client device 110 may include one or more sensors (e.g., heart rate monitors, blood oxygen saturation sensors, sleep sensors, accelerometers, motion sensors, thermal sensors, radio frequency identification (RFID) sensors, cameras, microphones, etc.) for gathering contextual data during a slideshow presentation. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In general, client device 106, client device 108, and client device 110 each represent one or more programmable electronic devices or combination of programmable electronic devices capable of executing machine readable program instructions and communicating with other computing devices (not shown) within data processing environment 100 via a network, such as network 102.

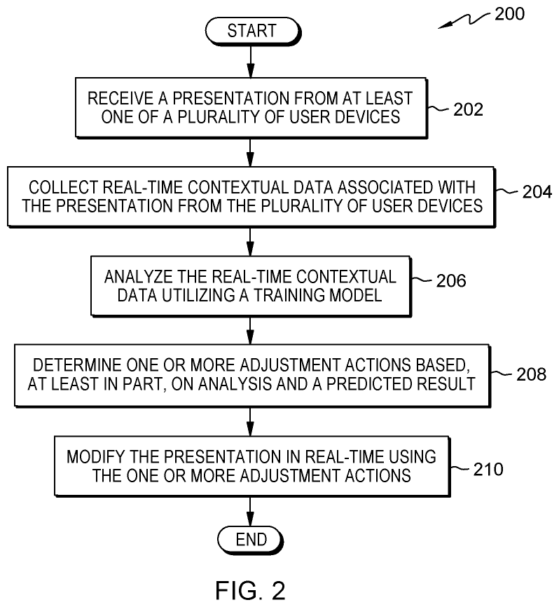

FIG. 2 is a flowchart depicting operational steps of a dynamic adjustment program, such as dynamic adjustment program 112, generally designated 200, for providing dynamic context-based presentation adjustments across one or more computer devices, in accordance with an embodiment of the present invention. Although FIG. 2 depicts operational steps of a dynamic adjustment program for providing dynamic context-based presentation slide adjustments across one or more computer devices, embodiments of the present invention may be similarly practiced for providing dynamic context-based video adjustments across one or more computer devices, such as during a video conference.

Dynamic adjustment program 112 receives a presentation from at least one of a plurality of user devices (202). In one embodiment, dynamic adjustment program 112 receives a presentation (i.e., a digital slideshow, group of presentation slides, etc.) from at least one of a plurality of user devices participating in the presentation. In one embodiment, dynamic adjustment program 112 prompts a user to open a presentation and accompanying slides to be presented. In one embodiment, the presentation may be presented remotely (e.g., shared via screenshare), such as during a group video conference, or presented in person (e.g., on a projection screen in a room or auditorium). In one embodiment, dynamic adjustment program 112 operates separately and concurrently with a presentation program with which the presentation was created. In another embodiment, dynamic adjustment program 112 may present the presentation independently of the presentation program with which the presentation was created, such as where the presentation is uploaded to dynamic adjustment program 112 manually by a user (i.e., a presenter).

Dynamic adjustment program 112 collects real-time contextual data associated with the presentation from the plurality of user devices (204). In one embodiment, dynamic adjustment program 112 monitors user activities across the plurality of user devices participating in the presentation (e.g., a user device of a presenter and one or more additional user devices for each attendee of the presentation) for associated contextual data based, at least in part, on a plurality of pre-defined preferences, where the plurality of pre-defined preferences include, but are not limited to, activities indicating feedback related to the presentation, editing activities, browsing activities, social media activities, text activities, speech activities (e.g. speech of a host, a presenter, a guest, a participant, etc.), and any other contextual data associated with the presentation that may impact user engagement. In one embodiment, dynamic adjustment program 112 monitors static contextual data associated with the presentation, where the static contextual data may include a stage setting (e.g., physical or virtual), an audience type, an audience size, an industry (e.g., corporate, education, etc.), a time of day, a temperature, a lighting level, volume of a speaker, a room size, a room brightness level, and any other data associated with the presentation that may impact user engagement, etc. In one embodiment, dynamic adjustment program 112 collects the real-time contextual data from the plurality of user devices utilizing one or more integrated components (e.g., input components, output components) and from one or more external sensors. In one embodiment, within a virtual format, dynamic adjustment program 112 may collect the real-time contextual data from social media, emails, text messages, live chats, and question and answer sessions, etc.

Dynamic adjustment program 112 analyzes the real-time contextual data utilizing a training model (206). In one embodiment, dynamic adjustment program 112 analyzes the real-time contextual data utilizing a training model by organizing the real-time contextual data by a type of data, where the type of data may be theme data, content data, or order data. For example, dynamic adjustment program 112 may organize real-time contextual data related to a room size, a room brightness, an audience type, and an audience size as theme data, as it relates to a scenario or setting of a presentation. In another example, dynamic adjustment program 112 may organize real-time contextual data related to audience feedback, audience questions, audience type, and speech of a presenter as content data, as it relates to overall content associated with the presentation. In yet another example, dynamic adjustment program 112 may organize real-time contextual data related to content of a current slide in the presentation, upcoming speech of a guest speaker, and audience reaction to a previous slide as order data, as it relates to overall process and order of the presentation. In one embodiment, dynamic adjustment program 112 analyzes the real-time contextual data utilizing a training model, where the training model is based on machine and deep learning models typically used for predictive analytics. In one embodiment, dynamic adjustment program 112 generates the training model by prompting a presenter (e.g., a creator of the presentation) to input various data points from a current presentation and historical data from prior presentation records in an offline scenario to develop the training model. In one embodiment, dynamic adjustment program 112 may utilize text to speech components, text to vector components, natural language processing, intention understanding, action prediction and results to refine the training model. In one embodiment, the training model is designed to output suggested adjustment actions that enhance user engagement and facilitate greater consumption of presented information.

Dynamic adjustment program 112 determines one or more adjustment actions based, at least in part, on the analysis of the real-time contextual data and a predicted result (208). In one embodiment, in an online scenario while the presentation is underway, dynamic adjustment program 112 determines one or more adjustment actions based, at least in part, on the analysis of the real-time contextual data and a predicted result, where determining the one or more adjustment actions includes inputting the analyzed real-time contextual data into the training model, and outputting the one or more adjustment actions and a predicted result associated with the implementation of each of the one or more adjustment actions. In one embodiment, the analyzed real-time contextual data can be inputted manually, such as by a presenter via a computing device, such as client device 106, client device 108, and client device 110. In another embodiment, dynamic adjustment program 112 receives the real-time contextual data directly from one or more computing devices, such as client device 106, client device 108, and client device 110, via one or more interconnected components and sensors. In yet another embodiment, dynamic adjustment program 112 automatically receives the real-time contextual data from one or more sensors and computing devices utilizing an internet of things (IoT) structure.

In one embodiment, dynamic adjustment program 112 determines one or more adjustment actions that are theme adjustment actions, including, but not limited to, background color adjustments, font type adjustments, font size adjustments, font color adjustments, image size adjustments, and image color adjustments, etc. In one embodiment, dynamic adjustment program 112 determines one or more theme adjustment actions utilizing a supervised machine learning model and predicted results based on a plurality of historical inputs and well-designed theme settings. For example, where dynamic adjustment program 112 receives real-time contextual data including a room size of a large auditorium for a presentation, based, at least in part, on historical inputs for similar scenarios (e.g., large room sizes) and predicted results (larger font is easier to read from a distance), dynamic adjustment program 112 may determine one or more theme adjustment actions including increasing font size and increasing contrast of a background within the presentation to enhance user engagement and optimize content consumption among the audience.

In one embodiment, dynamic adjustment program 112 determines one or more adjustment actions that are content adjustment actions, including, but not limited to, content simplification adjustments, content enrichment adjustments, content hide adjustments, and content rephrasing adjustments, etc. In one embodiment, dynamic adjustment program 112 determines one or more content adjustment actions utilizing natural language processing (NLP) techniques, natural language understanding (NLU) techniques, deep learning models, and predicted results based on a plurality of historical inputs. For example, where dynamic adjustment program 112 receives real-time contextual data including audience feedback and questions in response to certain speech of a presenter, dynamic adjustment program 112 may determine one or more content adjustment actions including content enrichment actions, such as amending a presentation slide corresponding to a question to include more detailed information sourced from an internet search or data repository, and a content rephrasing action, such as amending the presentation slide corresponding to the question with a variation of a statement of the information to enhance user engagement and optimize content consumption among the audience. In this embodiment, dynamic adjustment program 112 is capable of analyzing audience feedback, understanding an intention or concern related to the feedback, search and retrieve information to satisfy the intention or concern related to the feedback, and summarize the information in an extractive or abstractive way to enhance user engagement.

In one embodiment, dynamic adjustment program 112 determines one or more adjustment actions that are order adjustment actions, including, but not limited to, a next slide adjustment, a revert to a previous slide adjustment, and skip a subsequent slide adjustment, etc. In one embodiment, dynamic adjustment program 112 determines one or more order adjustment actions utilizing an NLP and NLU models to analyze real-time speech of a presenter, speech-to-text (STT) and voice command understanding (VCU) components, and a sequential deep learning model to predict a next slide based on current content, audience feedback, and the real-time speech of the presenter. For example, where dynamic adjustment program 112 receives real-time contextual data including audience feedback and questions in response to certain speech of a presenter and a current content on a slide, dynamic adjustment program 112 may determine one or more order adjustment actions including advance to a subsequent, or a previous slide, that further explains the current content.

Dynamic adjustment program 112 modifies the presentation in real-time using the one or more adjustment actions (210). In one embodiment, dynamic adjustment program 112 modifies the presentation in real-time using the one or more adjustment actions based on a type of adjustment to be performed. In one embodiment, dynamic adjustment program 112 modifies the presentation seamlessly in real-time utilizing theme adjustment actions, content adjustment actions, and order adjustment actions simultaneously to create a dynamic presentation that improves user experience, engagement, and productivity. In one embodiment, dynamic adjustment program 112 may rank one or more adjustment actions based on an effectiveness score and a predicted result that indicates how effectively the one or more adjustments actions will improve user experience, engagement, and productivity. For example, where there are no questions from the audience with regard to presented content and the room where the presentation is being shown is an auditorium, dynamic adjustment program 112 may initially rank a theme adjustment action, such as increase a font size or increase contrast of the slide, above a content adjustment action or an order adjustment action to improve user experience and engagement. In one embodiment, dynamic adjustment program 112 may generate a list of a pre-determined number of ranked adjustment actions, and modify the presentation with the pre-determined number of ranked adjustment actions, regardless of the type (e.g., theme, content, order).

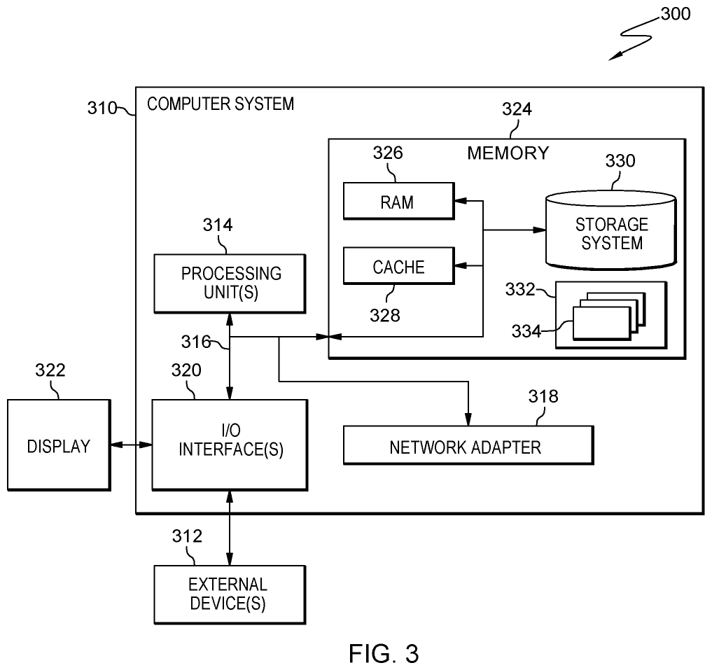

FIG. 3 is a block diagram depicting components of a data processing environment, such as server 104 of data processing environment 100, generally designated 300, in accordance with an embodiment of the present invention. It should be appreciated that FIG. 3 provides only an illustration of one implementation and does not imply any limitations with regard to the environments in that different embodiments may be implemented. Many modifications to the depicted environment may be made.

In the illustrative embodiment, server 104 in data processing environment 100 is shown in the form of a general-purpose computing device, such as computer system 310. The components of computer system 310 may include, but are not limited to, one or more processors or processing unit(s) 314, memory 324 and bus 316 that couples various system components including memory 324 to processing unit(s) 314.

Bus 316 represents one or more of any of several types of bus structures, including a memory bus or memory controller, a peripheral bus, an accelerated graphics port and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus and Peripheral Component Interconnect (PCI) bus.

Computer system 310 typically includes a variety of computer system readable media. Such media may be any available media that is accessible by computer system 310 and it includes both volatile and non-volatile media, removable and non-removable media.

Memory 324 can include computer system readable media in the form of volatile memory, such as random access memory (RAM) 326 and/or cache memory 328. Computer system 310 may further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk, such as a CD-ROM, DVD-ROM or other optical media can be provided. In such instances, each can be connected to bus 316 by one or more data media interfaces. As will be further depicted and described below, memory 324 may include at least one computer program product having a set (e.g., at least one) of program modules that are configured to carry out the functions of embodiments of the invention.

Program/utility 332, having one or more sets of program modules 334, may be stored in memory 324 by way of example and not limitation, as well as an operating system, one or more application programs, other program modules and program data. Each of the operating systems, one or more application programs, other program modules and program data or some combination thereof, may include an implementation of a networking environment. Program modules 334 generally carry out the functions and/or methodologies of embodiments of the invention as described herein. Computer system 310 may also communicate with one or more external device(s) 312, such as a keyboard, a pointing device, a display 322, etc. or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks, such as a local area network (LAN), a general wide area network (WAN) and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives and data archival storage systems may be used in conjunction with computer system 310.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams and combinations of blocks in the flowchart illustrations and/or block diagrams, can be implemented by computer readable program instructions.

These computer readable program instructions may be provided to a processor of a general purpose computer, a special purpose computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus or other device to cause a series of operational steps to be performed on the computer, other programmable apparatus or other device to produce a computer implemented process, such that the instructions which execute on the computer, other programmable apparatus or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A method for providing dynamic context-based presentation adjustments, the method comprising:
receiving, by one or more computer processors, a presentation from at least one of a plurality of user devices;
collecting, by the one or more computer processors, real-time contextual data associated with the presentation from at least one of the plurality of user devices;
analyzing, by the one or more computer processors, the real-time contextual data utilizing a training model utilizing text to speech components, text to vector components, intention understanding, and one or more action prediction results to refine the training model;
determining, by the one or more computer processors, one or more adjustment actions based, at least in part, on the analysis of the real-time contextual data; and
modifying, by the one or more computer processors, the presentation in real-time using the one or more adjustment actions.

2. The method of claim 1, wherein collecting real-time contextual data associated with the presentation further comprises:
monitoring, by the one or more computer processors, user activities across at least one of the plurality of user devices participating in the presentation for the real-time contextual data associated with the presentation based, at least in part, on browsing activities related to the presentation and social media activities related to the presentation.

3. (canceled)

4. The method of claim 1, wherein analyzing the real-time contextual data utilizing the training model, further comprises:
organizing, by the one or more computer processors, the real-time contextual data by a type of data, wherein the type of data is one or more of theme data, content data, and order data.

5. The method of claim 1, wherein the training model is based on a deep learning model.

6. The method of claim 1, wherein determining one or more adjustment actions further comprises:
inputting, by the one or more computer processors, real-time contextual data into the training model; and
outputting, by the one or more computer processors, the one or more adjustment actions and the predicted result associated with implementation of each of the one or more adjustment actions.

7. The method of claim 1, wherein modifying the presentation in real-time, further comprises:
ranking, by the one or more computer processor, the one or more adjustment actions based on an effectiveness score and the one or more action prediction results associated with implementation of each of the one or more adjustment actions, wherein the one or more adjustments actions are one of theme adjustment actions, content adjustment actions, and order adjustment actions;
generating, by the one or more computer processors, a list of a pre-determined number of ranked adjustment actions; and
modifying, by the one or more computer processors, the presentation with the pre-determined number of ranked adjustment actions.

8. A computer program product for providing dynamic context-based presentation adjustments, the computer program product comprising:
one or more computer readable storage media and program instructions stored on the one or more computer readable storage media, the stored program instructions comprising:
program instructions to receive a presentation from at least one of a plurality of user devices;
program instructions to collect real-time contextual data associated with the presentation from at least one of the plurality of user devices;
program instructions to analyze the real-time contextual data utilizing a training model utilizing text to speech components, text to vector components, intention understanding, and one or more action prediction results to refine the training model;
program instructions to determine one or more adjustment actions based, at least in part, on the analysis of the real-time contextual data; and
program instructions to modify the presentation in real-time using the one or more adjustment actions.

9. The computer program product of claim 8, wherein the program instructions to collect real-time contextual data associated with the presentation further comprise:
program instructions to monitor user activities across at least one of the plurality of user devices participating in the presentation for the real-time contextual data associated with the presentation based, at least in part, on browsing activities related to the presentation and social media activities related to the presentation.

10. (canceled)

11. The computer program product of claim 8,
wherein the program instructions to analyze the real-time contextual data utilizing the training model, further comprise program instructions to organize the real-time contextual data by a type of data, wherein the type of data is one or more of theme data, content data, and order data.

12. The computer program product of claim 8, wherein the program instructions to generate the training model are based on one or more deep learning models.

13. The computer program product of claim 8, wherein the program instructions to determine one or more adjustment actions further comprise:
program instructions to input real-time contextual data into the training model; and
program instructions to output the one or more adjustment actions and the predicted result associated with implementation of each of the one or more adjustment actions.

14. The computer program product of claim 8, wherein the program instructions to modify the presentation in real-time further comprise:
program instructions to rank the one or more adjustment actions based on an effectiveness score and the one or more action prediction results associated with implementation of each of the one or more adjustment actions, wherein the one or more adjustments actions are one of theme adjustment actions, content adjustment actions, and order adjustment actions;
program instructions to generate a list of a pre-determined number of ranked adjustment actions; and
program instructions to modify the presentation with the pre-determined number of ranked adjustment actions.

15. A computer system for providing dynamic context-based presentation adjustments, the computer system comprising:
one or more computer processors;
one or more computer readable storage media; and
program instructions stored on at least one of the one or more computer readable storage media for execution by at least one of the one or more computer processors, the stored program instructions comprising:
program instructions to receive a presentation from at least one of a plurality of user devices;
program instructions to collect real-time contextual data associated with the presentation from at least one of the plurality of user devices;
program instructions to analyze the real-time contextual data utilizing a training model utilizing text to speech components, text to vector components, intention understanding, and one or more action prediction results to refine the training model;
program instructions to determine one or more adjustment actions based, at least in part, on the analysis of the real-time contextual data; and
program instructions to modify the presentation in real-time using the one or more adjustment actions.

16. The computer system of claim 15, wherein the program instructions to collect real-time contextual data associated with the presentation further comprise:
program instructions to monitor user activities across at least one of the plurality of user devices participating in the presentation for the real-time contextual data associated with the presentation based, at least in part, on browsing activities related to the presentation and social media activities related to the presentation.

17. (canceled)

18. The computer system of claim 15, wherein the program instructions to analyze the real-time contextual data utilizing the training model, further comprise program instructions to organize the real-time contextual data by a type of data, wherein the type of data is one or more of theme data, content data, and order data.

19. The computer system of claim 15, wherein the program instructions to generate the training model are based on one or more deep learning models.

20. The computer system of claim, wherein the program instructions to determine one or more adjustment actions further comprise:
program instructions to input real-time contextual data into the training model; and
program instructions to output the one or more adjustment actions and the predicted result associated with implementation of each of the one or more adjustment actions.

21. The method of claim 1, wherein determining the one or more adjustment actions based, at least in part, on the analysis of the real-time contextual data, further comprises:
utilizing, by the one or more computer processors, a natural language processing model to analyze real-time speech of a presenter, speech-to-text components, and voice command components; and
utilizing, by the one or more computer processors, a sequential deep learning model to predict a next slide in the presentation based on current content, audience feedback, and the real-time speech of the presenter.

22. The method of claim 7, wherein the one or more adjustments actions are content adjustment actions, further comprises amending, by the one or more computer processors, a presentation slide corresponding to a question from an audience, wherein amending the presentation slide to include more detailed information sourced from an internet search or a date repository.
